(19) United States
(12) Patent Application Publication
(10) Pub. No.: US 2015/0096641 A1
(43) Pub. Date: Apr. 9, 2015

(54) FLOW REGULATING APPARATUS

(71) Applicant: PRATT & WHITNEY CANADA CORP., Longueuil (CA)

(72) Inventors: Bernard CHOW, Mississauga (CA); Tibor URAC, Mississauga (CA); Grigory RUKIN, Vaughan (CA); Derek BAXTER, Toronto (CA)

(73) Assignee: PRATT & WHITNEY CANADA CORP., Longueuil (CA)

(21) Appl. No.: 14/046,074

(22) Filed: Oct. 4, 2013

(51) Int. Cl. F15D 1/02

(52) U.S. Cl. CPC F15D 1/025
USPC 138/45

(57) ABSTRACT

A flow regulating device in a fluid system according to one embodiment may include a housing defining a cavity receiving an orifice body. The orifice body defines a bore extending axially therethrough and includes a flexible end section, with axial slits in one example, to allow the end section to be radially compressed to change a cross-section of a flow passageway when the bore of the orifice body is included in the flow passageway.

### TECHNICAL FIELD

The application relates generally to flow regulators and more particularly to adjustable fluid devices capable of controlling the flow of fluid through a body.

### BACKGROUND OF THE ART

Conventional “needle type” adjustable orifices adjust the flow by partially and adjustably obstructing an orifice through which the fluid passes, producing a small adjustable gap. However, these “needle type” adjustable orifices are prone to blockage, have a high risk for contamination and may require a filter in some applications. Furthermore, this flow control system is typically complex and costly. Conventional “fixed” orifice control systems require replacement of the orifice with a different diameter orifice to adjust the flow passing through the system. This type of control system is less complex and has lower costs, and reduces the risk of blockage as any debris can freely flow through the orifice and exit the system. However, conventional “fixed” orifice control systems require part replacement to achieve flow adjustment and require the user to keep a number of orifices of different sizes on hand.

Accordingly, there is a need for flow regulators designed to overcome the shortcomings of the conventional adjustable orifice systems.

### SUMMARY

In one aspect, there is provided a flow regulating device used in a fluid system, comprising: an orifice body defining a longitudinal axis and having a central bore extending axially therethrough between first and second ends of the orifice body, the fluid system in fluid communication with the bore at the second end, the first end having a plurality of circumferentially spaced-apart radially-flexible fingers extending axially from the first end, the fingers having ends adjacent the first end cooperating to define a flow-controlling orifice area in the bore, the fingers configured to reduce an orifice area in response to force applied radially inwardly adjacent the first end; a housing cooperatively receiving the orifice body and configured to apply an increasing radial inward force on the fingers when the orifice body is moved axially relative the housing; and an adjusting apparatus for adjusting the relative axial position of the housing and the orifice body.

In another aspect, there is provided a flow regulating device used in a fluid system, comprising: an orifice body defining a longitudinal axis and having a central bore extending axially therethrough between first and second ends of the orifice body, the orifice body having a conical end section coaxial with the bore at the first end and having a plurality of circumferentially spaced apart through-slits extending axially from the first end and radially through the body so as to define radially-moveable fingers at the first end; a housing defining a cavity extending between one and another ends of the housing and receiving the orifice body, the cavity including a conical section at said one end of the housing configured to cooperate with the orifice body first end, the housing conical section configured to radially compress the fingers when the orifice body is moved in the cavity relative the housing, the fingers defining an adjustable transverse cross section of a flow passageway extending through the orifice body and housing, the flow passageway having first and second openings in fluid communication with the fluid system; and an adjusting apparatus for adjusting radial compression of the housing to the fingers of the orifice body to adjustably restrict said cross section of the flow passageway.

In a further aspect, there is provided a flow regulating system used in a fluid system, comprising: a first flow passageway defining first and second openings of the system located at respective opposed ends of the first flow passageway; a second flow passageway in fluid communication with and extending from the first flow passageway to a distal end of the second flow passageway, the distal end forming a third opening of the system; a fluid flow entering the first flow passageway through the first opening, a first portion of the fluid flow passing through the first flow passageway to the second opening, a second portion of the fluid flow passing through part of the first flow passageway and through the second flow passageway to the third opening; the first flow passageway including a bore extending through an orifice body, the orifice body extending through a cavity of a housing and having a truncated conical end section with a plurality of circumferentially spaced apart axial slits in fluid communication with the bore, the truncated conical end section of the orifice body being radially compressible in a truncated conical section of the cavity, the bore and spaces in the respective slits in combination defining a cross section of the first flow passageway; and an adjusting apparatus for adjusting radial compression of the housing to the truncated conical end section of the orifice body to change an area defined by said cross section of the first flow passageway to cause changes of pressure drop of the fluid flow over the first flow passageway, thereby resulting in corresponding pressure changes of the second portion of the fluid flow at the third opening.

### DESCRIPTION OF THE DRAWINGS

Reference is now made to the accompanying figures in which:

FIG. 1 is a schematic side cross-sectional view of a gas turbine engine;

FIG. 2 is a cross-sectional view of a flow regulating device according to one embodiment used in the fluid systems of the gas turbine engine of FIG. 1;

FIG. 3 is an isometric view of the flow regulating device of FIG. 2, with a front half cut away to show the interior thereof;

FIG. 4 is an isometric view of an orifice body of the flow regulating device of FIG. 2;

FIG. 5 is a cross-sectional view of a flow regulating device according to another embodiment, used in a fluid system of the gas turbine engine of FIG. 1; and

FIG. 6 is a partial cross-sectional view of the flow regulating device taken along line 6-6 of FIG. 2.

It will be noted that throughout the appended drawings, like features will be identified by like reference numerals.

### DETAILED DESCRIPTION

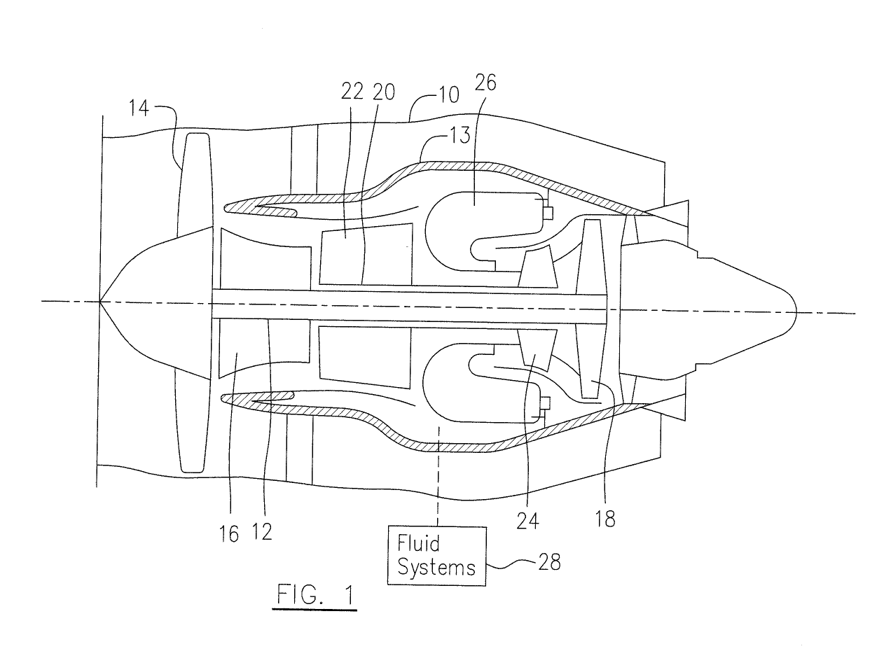

FIG. 1 illustrates a turbofan gas turbine aircraft engine as an example of the application of the described subject matter, including a housing or nacelle annular outer case 10, a annular core casing 13 a low pressure spool assembly (not numbered) which includes a fan assembly 14, a low pressure compressor assembly 16 and a low pressure turbine assembly 18 connected together by a shaft 12, and a high pressure spool assembly (not numbered) which includes a high pressure compressor assembly 22 and a high pressure turbine assembly 24 connected together by a hollow shaft 20 which is positioned coaxially around the shaft 12. The core casing 13 surrounds the low and high pressure assemblies in order to define a main fluid path (not numbered) therethrough. In the main fluid path there is provided an annular combustor 26 constituting a gas generator section. The engine also includes various fluid systems which are indicated by block 28, in order to provide air or liquid for engine functions, such as a fuel system, an oil system, etc. The engine 10 represents but one possible example of a device in which a fluid flow system incorporating the present invention may be employed.

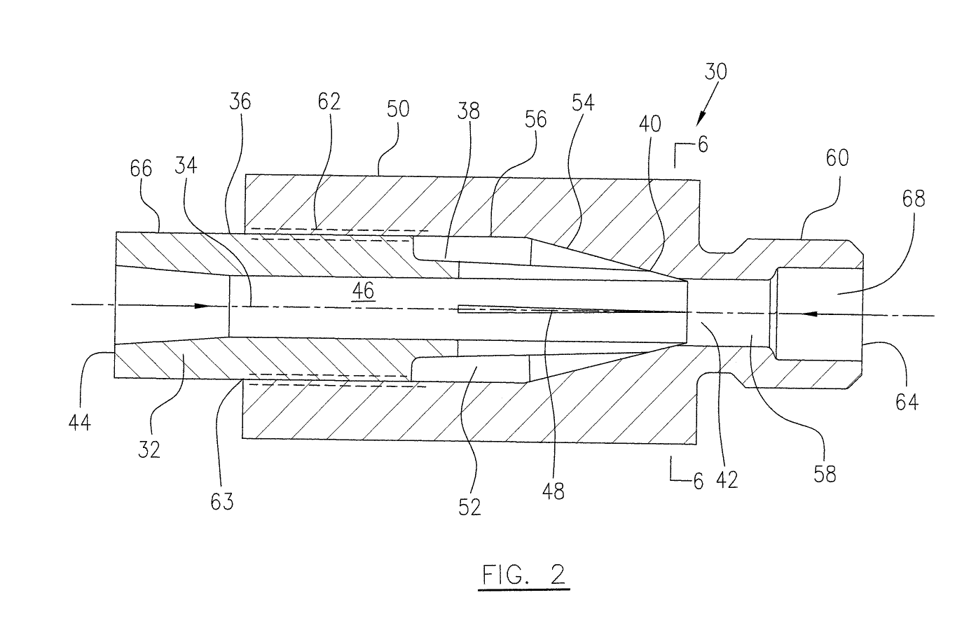

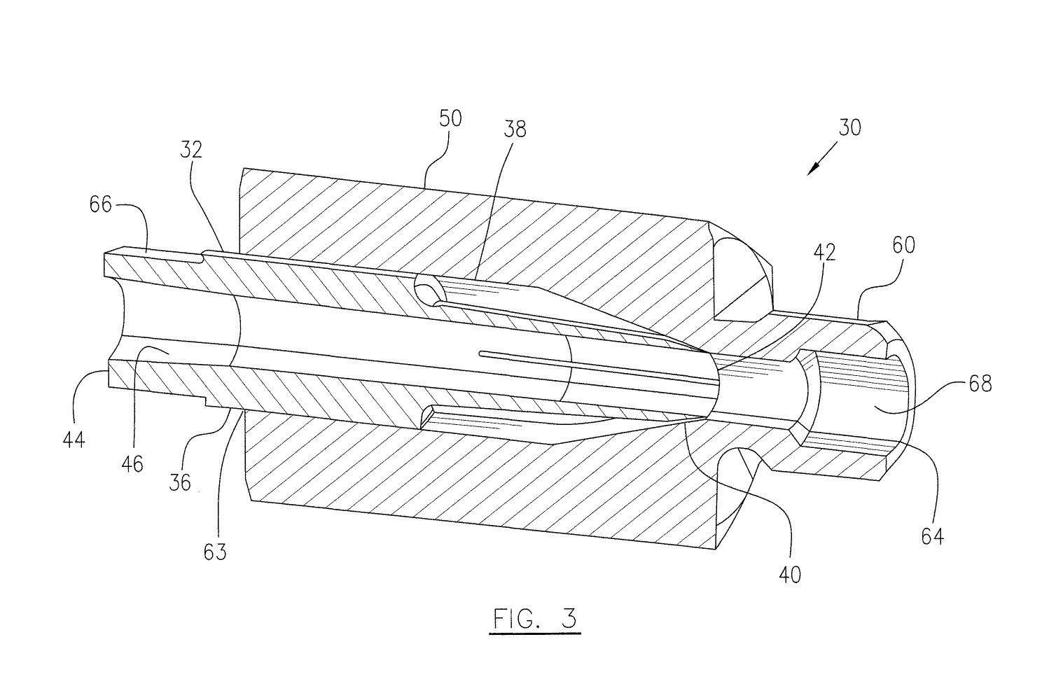

Referring to FIGS. 2-4 and 6, a fluid regulating device 30 according to one embodiment, is used in such fluid systems 28 of the engine shown in FIG. 1. The device 30 may include an orifice body 32 having a substantially cylindrical configuration and defining a longitudinal axis 34. The orifice body 32 may include a cylindrical body 36 and a cylindrical extension 38 which may have a diameter smaller than the diameter of the cylindrical body 36. The cylindrical extension 38 may further include a truncated conical end section 40. A flattened tip end of the truncated conical end section 40 forms a first end 42 of the orifice body 32 and a free end of the cylindrical body 36 forms a second end 44 of the orifice body 32. The orifice body 32 may define a bore 46 extending therethrough between the opposed first and second ends 42, 44 of the orifice body 32. The longitudinal axis 34 of the orifice body 32 may also be the central axis of the bore 46.

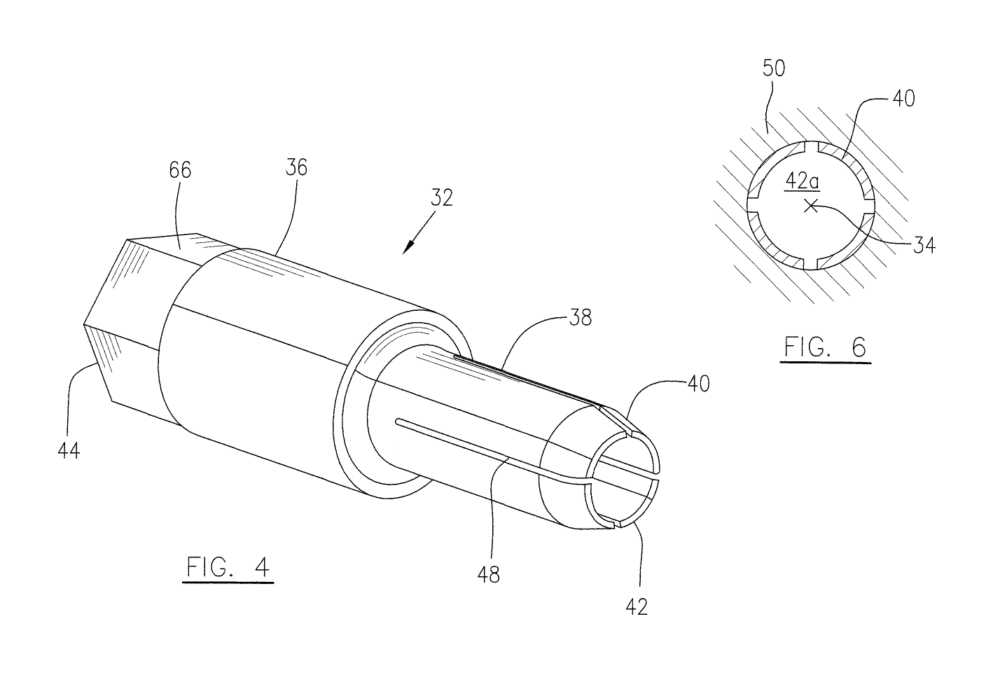

With respect to the longitudinal axis 34, the cylindrical extension 38 may be provided with a plurality of circumferentially spaced apart through-slits 48 (see FIG. 4) extending axially from the first end 42 towards the cylindrical body 36. The axial slits 48 may extend radially through the entire body at the truncated conical end section 40, and may also extend along part of the cylindrical extension 38, and thus are in fluid communication with the bore 46 such that the truncated conical end section 40 and part of the cylindrical extension 38 are divided by the slits 48 into a number of circumferentially spaced cantilevered beams or fingers (not numbered) between the slits which can be radially compressed to reduce the diameter of the bore 46 in this section.

A housing 50 which may be substantially cylindrical. The inner wall of the housing 50 may define a cavity 52 for receiving the orifice body 32. The cavity 52 may extend through the housing 50 in the longitudinal direction and may include a truncated conical section 54 positioned between a large cylindrical section 56 and a small cylindrical section 58 of the cavity 52, such that the large cylindrical section 56 and the small cylindrical section 58 extend towards opposed ends of the housing 50. A fitting 60 may be incorporated with the small cylindrical section 58 of the cavity 52, to form one of the opposed ends of the housing 50 for connecting with another part (not shown) of the fluid system 28 of the engine.

A threading engagement 62 may be provided between the cylindrical sections 36, 56 of the orifice body 32 and the inner wall of the housing 50 for adjusting an axial position of the orifice body 32 relative to the housing 50, resulting in the truncated conical end section 40 of the orifice body 32 being radially compressed in the truncated conical section 54 of the cavity 52 by the inner wall of the housing 50. However, the threading engagement 62 may be replaced by any other suitable movement apparatus such as mechanical, electronic or pneumatic devices.

According to one embodiment the large cylindrical section 56 of the cavity 52 may have an opening 63 defined at one of the opposed ends thereof, to allow the end 44 of the orifice body 32 to extend axially outwardly therefrom. The small cylindrical section 58 of the cavity 52 may define an opening 64 at the other of the opposed ends thereof. The opening 64 thus also forms an opening of the fitting 60 of the housing 50. The orifice body 32 may be provided with at least one flat surface 66 extending tangentially with respect to the longitudinal axis 34. For example, the at least one flat surface 66 may be formed as a part of a hexahedral end section (not numbered) of the orifice body 32 located at the end 44 for working with a hand tool to rotate the orifice body 32 about the longitudinal axis 34.

The bore 46 of the orifice body 32 and part of the cavity 52, for example the small cylindrical section 58 of the cavity 52, therefore form a flow passageway 68 extending through the orifice body 32 and the housing 50, defining a first opening formed by the opening 64 at the end of the fitting 60, and a second opening at the end 44 of the orifice body 32. The flow passageway 68 may include a cross section 42a (see FIG. 6) transverse to the longitudinal axis 34 defined by the fingers. Such cross section 42a includes the space in the bore 46 and spaces in the respective slits 48 located, for example at the flattened first end 42 of the truncated conical end section 40 of the orifice body 32. This cross section 42a of the flow passageway 68 may be adjustable when the truncated conical end section 40 of the orifice body 32 is radially compressed by the inner wall of the housing 50 at the truncated conical section 54 of the cavity 52 of the housing 50, for example resulting from adjustment of the threading engagement 62 to cause relative axial movement between the orifice body 32 and the housing 50. The flow regulating device 30 may be used in one of the fluid systems 28 of the engine to allow a fluid flow to pass through the flow passageway 68 thereof in either direction. The axial position of the orifice body 32 in the housing 50 may be pre-adjusted to have the cross section of the flow passageway 68 at the flattened first end 42 of the orifice body 32 meet a required size flow-through-area, in order to thereby result in a required flow pressure drop over the flow passageway 68.

Depending on the application, the materials of the orifice body 32 and the housing 50 may be selected to have different thermal expansion coefficients as a means of thermal adjustment. For this alternative design, the flow regulating device 30 can not only be adjusted manually by adjusting the axial position of the orifice body 32 relative to the housing 50, but can also be automatically adjusted by housing temperature changes which result in diameter changes of the cavity 52 of the housing 50 and the orifice body 32 based on their respective thermal expansion coefficients, which is referred to as a “passive flow control system”. For example, the housing 50 may be made of aluminium and the orifice body 32 may be made of stainless steel. When the temperature of the housing 50 decreases, the aluminium housing 50 will shrink more than the stainless steel orifice body 32 and therefore the cross section 42a of the flow passageway 68 at the flattened first end 42 of the orifice body 32 will reduce (without adjusting an axial position of the orifice body 32 relative to the housing 50) to constrict fluid flow. Depending on the application, this thermal adjustment may be advantageous if the system is designed based on thermal changes and can be self-regulating.

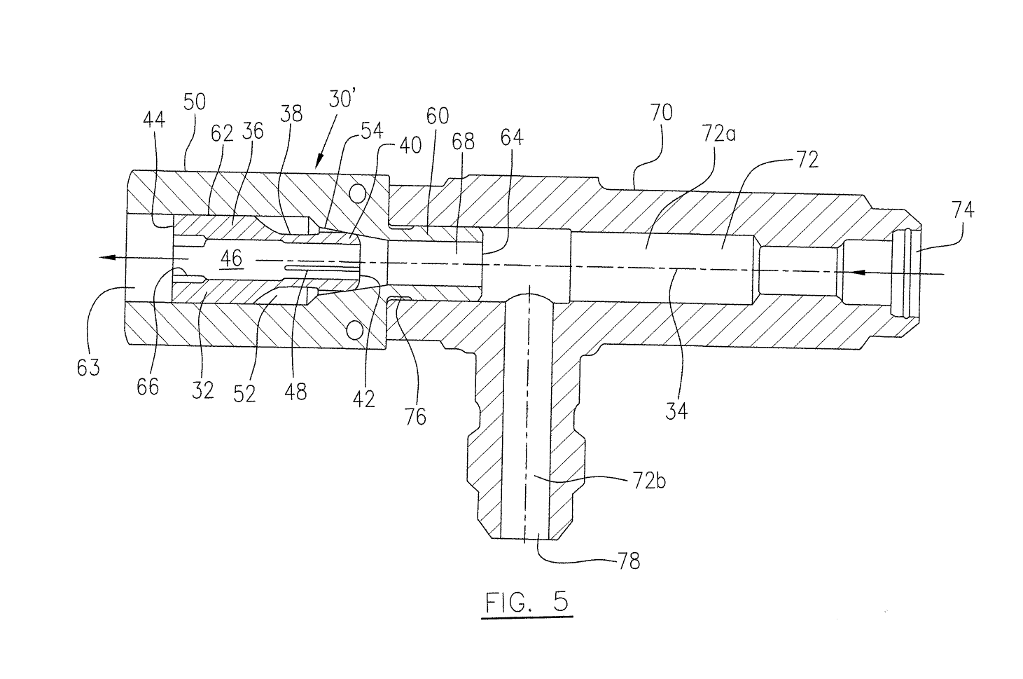

Referring to FIG. 5, the flow regulating device 30′ according to another embodiment is similar to the flow regulating device 30 shown in FIG. 2. Similar features indicated by similar reference numerals will not be redundantly described herein and the differences between the two embodiments will be further described below.

The second end 44 of the orifice body 32 may be received within the cavity 52 of the housing 50 instead of extending axially outwardly from the opening 63 of the housing 50 as shown in FIG. 2. Therefore, the opening 63 at the one end of the housing 50 forms the second opening of the flow passageway 68. The flat surfaces 66 may be provided as a hexahedral end section of the bore 46 of the orifice body 32. Therefore, a hand tool may be extended through the opening 63 of the housing 50 and inserted into the hexahedral end section 66 of the bore 46 for rotating the orifice body 32 within the housing 50 in order to adjust the axial position of the orifice body 32 relative to the housing 50.

Optionally, the flow regulating device 30′ may further include, for example a three-way connector 70 having an internal passage 72 with an inlet 74, a first outlet 76 and a second outlet 78. The connector 70 may be attached to the housing 50 to allow the fitting 60 to be inserted into the first outlet 76 of the connector 70, to thereby communicate the internal passage 72 with the cavity 52 of the housing 50 through the first outlet 76 and the opening 64 which is also the first opening of the flow passageway 68. When the flow regulating device 30′ is installed in one of the fluid systems 28 of the engine shown in FIG. 1, the inlet 74 may be adapted for introducing the fluid flow passing through the internal passage 72 or at least part of the internal passage 72 and then into the flow passageway 68 towards the second opening 63 of the housing 50. The second outlet 78 of the connector 70 may be adapted for output of a reference pressure corresponding to a pressure drop of the fluid flow passing through the flow passageway 68. For example, a pressure indicator (not shown) may be installed in the second outlet 78 such that the pressure indicator will show the reference pressure corresponding to a predetermined flow pressure drop over the flow passageway 68 as a result of an adjustment of the axial position of the orifice body 32 relative to the housing 50. Other components may be installed in the second outlet 78 of the connector 70 as required by the fluid system 28 of FIG. 1.

The three-way connector 70 according to this embodiment may have a T-shaped configuration, having a first part 72a of the internal passage 72 and a second part 72b of the internal passage 72, the first and second parts 72a, 72b being perpendicular to each other. The first part 72a of the internal passage may extend from the inlet 74 to the first outlet 76 and may be substantially coaxial with respect to the flow passageway 68, thereby forming part of, or an extension of the flow passageway 68. The second part 72b of the internal passage may be in fluid communication with and extend from the extended flow passageway 68 (the first part 72a of the internal passage 70) to a distal end (not numbered) of the second part 72b of the internal passage 70. The second outlet 78 of the connector 70 is formed at the distal end of the second part 72b.

In this embodiment, the pressure drop can be achieved in either direction. For example, fluid may enter the device 30′ from inlet 74 or from opening 63, and a pressure change at the second outlet 78 can be observed when the cross-section 42a of the flow passageway is adjusted.

The described embodiments of the flow regulating device allow pre-adjustment of the flow and pressure of the fluid systems in gas turbine engines while minimizing potential contamination in the fluid systems. Additional parts beyond basic hand tools may not be required for adjustment of the flow regulating device. The described embodiments of the flow regulating device may reduce complexity as compared to conventional adjustable orifice systems, and thus may reduce overall cost.

The above description is meant to be exemplary only, and one skilled in the art will recognize that changes may be made to the embodiments described without departing from the scope of the described subject matter. For example, the housing for containing the orifice body may be a stand-alone part or may be a truncated conical section of the cavity and may be integrated into any device, such a casing or housing of another engine component, thereby eliminating the orifice housing part and reducing overall part count. The truncated conical section described in the above embodiments need not be truncated, nor conical. Besides conical shapes, other progressively-reducing area shapes (e.g. trapezoids) may be used. Alternately, any suitable flexible configuration which reduces bore area in response to radial inward force from the housing, as a function of relative position between housing and orifice body, is within the scope of the present disclosure. Furthermore, as previously noted, the present apparatus may be applicable in any suitable fluid system, and not just the gas turbine example provided. Modifications which fall within the scope of the described subject matter will be apparent to those skilled in the art, in light of a review of this disclosure, and such modifications are intended to fall within the appended claims.

1. A flow regulating device used in a fluid system, comprising:
an orifice body defining a longitudinal axis and having a central bore extending axially therethrough between first and second ends of the orifice body, the fluid system in fluid communication with the bore at the second end, the first end having a plurality of circumferentially spaced-apart radially-flexible fingers extending axially from the first end, the fingers having ends adjacent the first end cooperating to define a flow-controlling orifice area in the bore, the fingers configured to reduce an orifice area in response to force applied radially inwardly adjacent the first end;
a housing cooperatively receiving the orifice body and configured to apply an increasing radial inward force on the fingers when the orifice body is moved axially relative the housing; and
an adjusting apparatus for adjusting the relative axial position of the housing and the orifice body.

2. The flow regulating apparatus of claim 1 wherein distal ends of the fingers cooperate with the housing to define an outlet area of the bore.

3. The flow regulating apparatus of claim 1 wherein the orifice body first end has a conical shape and is matingly received in a conical cavity in the housing.

4. A flow regulating device used in a fluid system, comprising:
an orifice body defining a longitudinal axis and having a central bore extending axially therethrough between first and second ends of the orifice body, the orifice body having a conical end section coaxial with the bore at the first end and having a plurality of circumferentially spaced apart through-slits extending axially from the first end and radially through the body so as to define radially-moveable fingers at the first end;
a housing defining a cavity extending between one and another ends of the housing and receiving the orifice body, the cavity including a conical section at said one end of the housing configured to cooperate with the orifice body first end, the housing conical section configured to radially compress the fingers when the orifice body is moved in the cavity relative the housing, the fingers defining an adjustable transverse cross section of a flow passageway extending through the orifice body and housing, the flow passageway having first and second openings in fluid communication with the fluid system; and
an adjusting apparatus for adjusting radial compression of the housing to the fingers of the orifice body to adjustably restrict said cross section of the flow passageway.

5. The flow regulating device as defined in claim 1 wherein the adjusting apparatus comprises a threading engagement provided between the housing and the orifice body for adjusting an axial position of the orifice body relative to the housing.

6. The flow regulating device as defined in claim 1 wherein the housing and orifice body have different thermal expansion coefficients.

7. The flow regulating device as defined in claim 1 wherein the adjusting apparatus is incorporated with the housing and the orifice body, the housing being made of aluminum and the orifice body being made of stainless steel.

8. The flow regulating device as defined in claim 1 wherein the cavity defines a first opening at said one end of the housing to form the first opening of the flow passageway, and wherein the second end of the orifice body extends axially outwardly from a second opening at said another end of the housing, the bore of the orifice body forming the second opening of the flow passageway in the second end of the orifice body.

9. The flow regulating device as defined in claim 1 wherein the cavity defines a first opening at said one end of the housing to form the first opening of the flow passageway, wherein the cavity defines a second opening at said another end of the housing to form the second opening of the flow passageway.

10. The flow regulating device as defined in claim 1 wherein the orifice body comprises a cylindrical section threadingly engaged with the cavity of the housing.

11. The flow regulating device as defined in claim 7 wherein the orifice body comprises at least one flat surface extending tangentially with respect to the longitudinal axis, the at least one flat surface being located at the second end of the orifice body.

12. The flow regulating device as defined in claim 1 further comprising a three-way connector including an internal passage having an inlet, a first outlet and a second outlet, the connector being attached to the housing to communicate the internal passage of the connector with the cavity through the first outlet of the connector and the first opening of the flow passageway, the inlet of the connector being adapted for introducing the fluid flow passing through the flow passageway and the second outlet of the connector being adapted for output of a reference pressure corresponding to a pressure drop of the fluid flow passing through the flow passageway.

13. The flow regulating device as defined in claim 9 wherein the three-way connector comprises a T-shaped configuration.

14. The flow regulating device as defined in claim 9 wherein the housing comprises a fitting defining the first opening of the flow passageway, the fitting forming an end of the housing and being inserted into the first outlet of the three-way connector.

15. A flow regulating system used in a fluid system, comprising:
a first flow passageway defining first and second openings of the system located at respective opposed ends of the first flow passageway;
a second flow passageway in fluid communication with and extending from the first flow passageway to a distal end of the second flow passageway, the distal end forming a third opening of the system;
a fluid flow entering the first flow passageway through the first opening, a first portion of the fluid flow passing through the first flow passageway to the second opening, a second portion of the fluid flow passing through part of the first flow passageway and through the second flow passageway to the third opening;
the first flow passageway including a bore extending through an orifice body, the orifice body extending through a cavity of a housing and having a truncated conical end section with a plurality of circumferentially spaced apart axial slits in fluid communication with the bore, the truncated conical end section of the orifice body being radially compressible in a truncated conical section of the cavity, the bore and spaces in the respective slits in combination defining a cross section of the first flow passageway; and
an adjusting apparatus for adjusting radial compression of the housing to the truncated conical end section of the orifice body to change an area defined by said cross section of the first flow passageway to cause changes of pressure drop of the fluid flow over the first flow passageway, thereby resulting in corresponding pressure changes of the second portion of the fluid flow at the third opening.

16. The flow regulating system as defined in claim 12 wherein said cross section of the first flow passageway is defined at a flattened tip end of the truncated conical end section of the orifice body.

17. The flow regulating system as defined in claim 12 wherein the second flow passageway is connected to the first flow passageway at a location upstream of said cross section of the first flow passageway.

18. The flow regulating system as defined in claim 12 wherein the adjusting apparatus comprises a threading engagement provided between the housing and the orifice body for adjusting an axial position of the orifice body relative to the housing.

19. The flow regulating device as defined in claim 12 wherein the housing and orifice body having different thermal expansion coefficients.
